(19) United States
(12) Patent Application Publication
(10) Pub. No.: US 2015/0336219 A1
(43) Pub. Date: Nov. 26, 2015

(54) COMPOSITE MATERIALS AND METHODS FOR LASER MANUFACTURING AND REPAIR OF METALS

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/533,390

(22) Filed: Nov. 5, 2014

Related U.S. Application Data
(63) Continuation-in-part of application No. 13/755,098, filed on Jan. 31, 2013.
Application No. 13/755,098 is a continuation-in-part of application No. 13/005,656, filed on Jan. 13, 2011.

(51) Int. Cl. B23K 35/36; C23C 4/04; B23K 26/34; B23K 35/24; B23P 6/00

(52) U.S. Cl. CPC B23K 35/3601; B23K 35/3603; B23K 35/3605; B23K 35/3608; B23K 35/24; B23P 6/00; B23K 26/34; C23C 4/04

(57) ABSTRACT

Composite materials (2, 8) disclosed herein include a metal alloy (4, 10) and a flux composition (6, 12). The metal alloy may be a superalloy, and a volume ratio of the flux composition to the metal alloy may range from about 30:70 to about 70:30. The composite materials may be in the form of particles (2) containing a core (6) surrounded by a metallic layer (4), in which the core contains the flux composition and the metallic layer contains the metal alloy. The composite materials may also be in the form of fused materials (8) in which the metal alloy (10) and the flux composition (12) are randomly distributed and randomly oriented. Also disclosed are processes involving melting of composite materials to form metal deposits (32).

This application is a continuation-in-part of U.S. application Ser. No. 13/755,098 (attorney Docket No. 2012P28301US) filed on Jan. 31, 2013, and published as US 2013/0136868 A1 on May 30, 2013, which is a continuation-in-part of U.S. application Ser. No. 13/005,656 (attorney Docket No. 2010P13119US) filed on Jan. 13, 2011, and published as US 2012/0181255 A1 on Jul. 19, 2012, the entire contents of both of which are incorporated herein by reference.

### FIELD OF THE INVENTION

This application relates to materials technology in general and more specifically to composite materials and methods that are useful for manufacturing and repairing metallic materials including superalloys.

### BACKGROUND OF THE INVENTION

Laser powder deposition (aka. laser cladding with powdered filler) is a process in which a thin layer of a metallic powder is melted using an energy beam to form a metal deposit. This approach to metal processing has generated recent interest due to its possible use in the fabrication and repair of complex objects formed from a variety of metallic materials and alloys. For example, selective laser melting (SLM) is a powder bed process involving the deposition of a thin layer of a metal powder onto a substrate, followed by scanning of the powder surface with a high power laser beam rastered to generate heat which causes the powder particles to melt and form a melt pool which solidifies into a metal deposit layer. Once the layer has been deposited another layer of powder may then be added which is again melting by the laser. Successive layers can be deposited upon one another in this manner to fabricate three-dimensional objects in a process known as laser additive manufacturing (LAM). While SLM is generally limited to flat working surfaces, laser microcladding is a 3D-capable process that deposits a small, thin layer of material onto a surface by using a laser beam to melt a flow of powder propelled towards the surface by a jet of gas.

Although the various forms of laser powder deposition offer great potential for fabricating and repairing complex objects, they are limited by certain disadvantages which often inhere to the use of metallic powders. One disadvantage relates to the reactivity of metallic powders with components in air such as oxygen and nitrogen. Reactive metals such as iron, aluminum and titanium can react with air to form impurities including metal oxides, and metal nitrides—in which the rate of such unwanted reactions generally increases as the surface area of the metallic powder increases. Metallic powders also tend to readily adsorb moisture which can also react to form metal oxides and may also lead to unwanted porosity in metallic objects formed using laser powder deposition. For high strength steels the moisture is also a source of hydrogen which is known to lead to delayed cracking.

These problems with air and moisture can be especially problematic for high-temperature materials requiring more rigorous process conditions to affect laser powder deposition. Superalloys, for example, are recognized to be among the most difficult materials to laser process because of their relatively high melting points, relatively low ductility, as well as their susceptibility to undergoing weld solidification cracking and strain age cracking. These mechanical defects can be caused or exacerbated by the presence of air and/or water during laser processing.

The term “superalloy” is used herein as it is commonly used in the art, i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g. IN 100, IN 700, IN 713, IN 738, IN 792, IN 939), Rene alloys (e.g. Rene N5, Rene 41, Rene 80, Rene 108, Rene 142, Rene 220), Haynes alloys (282), Mar M, CM 247, CM 247 LC, C263, 718, X-750, ECY 768, 282, X45, PWA 1480, PWA 1483, PWA 1484, CMSX single crystal alloys (e.g., CMSX-4, CMSX-8, CMSX-10), GTD 111, GTD 222, MGA 1400, MGA 2400, PSM 116, Mar-M-200, Udimet 600, Udimet 500 and titanium aluminide. The terms “metal,” “metallic material,” “alloy,” and “metal alloy” are used herein in a general sense to describe pure metals, semi-pure metals and metal alloys.

To mitigate the harmful effects of air, the melt pool resulting from laser powder deposition is often shielded by applying an inert gas, such as argon and helium. However, such shielding does not remove already existing oxides that tend to form on the outside of metal powders during manufacture, storage and handling. As a result, such oxide coated metal fillers must often be reduced during melt processing to avoid porosity and other defects in the resulting metallic deposit. Post-deposition processes such as hot isotatic pressing (HIP) are also often used to collapse pores (voids), inclusions and cracks in order to improve the properties of laser-deposited metals. To prevent moisture adsorption it is also common to store metal powder fillers in pre-heated hoppers. Such protective and post-processing measures are particularly important for metallic powders containing highly reactive metals (e.g., superalloys) and for fine powders having high surface areas.

### BRIEF DESCRIPTION OF THE DRAWINGS

The invention is explained in the following description in view of the drawings that show:

FIG. 1 depicts a sectional view of a composite particle containing a metallic outer layer surrounding an inner flux-containing core.

FIG. 2 depicts a composite glass particle containing a metal alloy and a flux composition.

FIGS. 3A-3C depict composite materials having different shapes.

FIG. 4 depicts a method of processing a pre-placed composite material to form a metal deposit.

FIG. 5 depicts a method of forming a metal deposit by directing a composite material into an energy beam.

### DETAILED DESCRIPTION OF THE INVENTION

Applicants have recognized that a need exists to discover alternative materials and methods for addressing the harmful effects that air and moisture can have on laser powder deposition of metals. Ideal materials and methods would enable laser powder deposition of metal in a variety of contexts (e.g., metal component fabrication and repair, bulk metal production) to produce metallic materials containing fewer impurities and defects resulting from exposure to air and moisture—while at the same time avoiding the need to rely upon currently-employed protective techniques such as using pre-heated powder hoppers, inert shielding gases and/or vacuum conditions, reducing agents, and post-process hot isostatic pressing (HIP). Ideal materials and methods would also be compatible with laser processing of superalloys, or superalloy precursors to form superalloys.

It is proposed that the problems associated with air and moisture can be mitigated by employing novel composite materials containing a metal and a flux composition. Such composite materials are expected to be effective at reducing moisture content and avoiding unwanted reactions with air, because the metal material and the flux composition are intimately bound together in solid, particulate forms that are relatively stable (inert) under atmospheric conditions and are less prone to moisture adsorption compared to conventional metallic filler powders. Composite materials described herein can offer additional protection from air and moisture that cannot be attained using separate powders of metal and flux (as powdered mixtures or distinct powder layers), because the composite materials include a physical or chemical barrier that resists the adsorption (and permeation) of atmospheric agents.

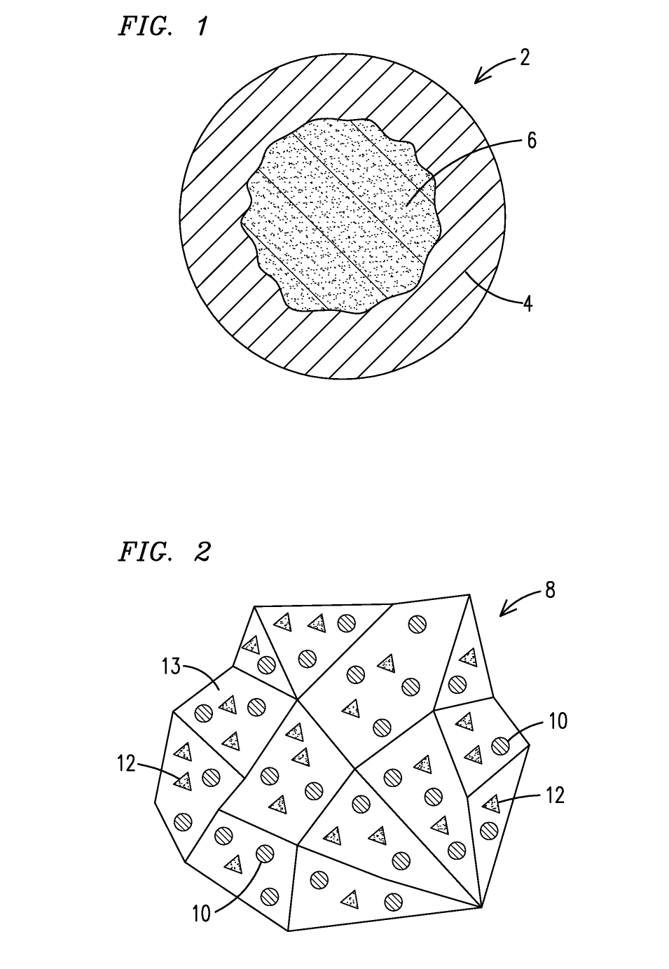

FIG. 1 illustrates one embodiment of a composite material 2 in the form of coated particles comprising a flux-containing core 6 surrounded (coated) by a metallic layer 4. In this non-limiting illustration the metallic layer 4 acts as a physical barrier that resists adsorption and permeation by atmospheric agents such as oxygen, nitrogen and moisture. In some embodiments the metallic layer 4 may also contain at least one metal (such as nickel) that is chemically resistant to atmospheric agents including oxygen and nitrogen.

The metallic layer 4 may contain a pure metal such as nickel, a metal alloy such as a superalloy, or combinations of different metals and alloys. Superalloys may contain mixtures of base metals (e.g., Ni, Fe and Co) along with other metals, metalloids and nonmetals such as chromium, molybdenum, tungsten, tantalum, aluminum, titanium, zirconium, niobium, rhenium, yttrium, vanadium, carbon, boron, and hafnium, to name a few. Examples of superalloys include alloys sold under the trademarks and brand names Hastelloy, Inconel alloys (e.g. IN 100, IN 700, IN 713, IN 738, IN 792, IN 939), Rene alloys (e.g. Rene N5, Rene 41, Rene 80, Rene 108, Rene 142, Rene 220), Haynes alloys (282), Mar M, CM 247, CM 247 LC, C263, 718, X-750, ECY 768, 282, X45, PWA 1480, PWA 1483, PWA 1484, CMSX single crystal alloys (e.g., CMSX-4, CMSX-8, CMSX-10), GTD 111, GTD 222, MGA 1400, MGA 2400, PSM 116, Mar-M-200, Udimet 600, Udimet 500 and titanium aluminide.

The metallic layer 4 may contain a metal content that matches the composition of a metallic deposit to be formed through melt processing, or it may contain a single metal or a subset of metals contained in the metallic deposit. Thus, as explained below in greater detail, a laser powder deposition using the composite material 2 of FIG. 1 may be used to form a melt pool having a metal composition identical to the metallic layer 4, or to form a melt pool whose metal composition is supplemented using at least one additional metal filler or metal-containing flux material.

The metallic layer 4 may be formed of a single metal layer having a homogeneous composition or may be formed of a single metal layer that is compositionally graded. In some embodiments, for instance, the metallic layer 4 of FIG. 1 may be graded such that the outer surface contains a higher proportion of nickel than the inner surface of the metallic layer 4—providing greater protection for reactive metals (e.g., Al, Ti and Fe) contained in the metallic layer 4. Upon melting, the metallic components of a compositionally-graded metallic layer 4 may then undergo mixing such that a resulting metal deposit is a homogeneous composition having a desired alloy content. The metallic layer 4 may also be formed of more than one metal layer having the same or different metallic compositions. By illustration, in some embodiments the composite material 2 of FIG. 1 comprises a flux-containing core 6 surrounded (coated) by an intermediate superalloy layer which is surrounded (coated) by an outer layer of nickel.

As explained below in greater detail, the flux-containing core 6 comprises a flux composition providing at least one protective function during melt processing of the composite material 2. Flux compositions may include one or more inorganic compound such as a metal oxide, a metal halide, a metal oxometallate, a metal carbonate, or mixtures thereof, and may also include one or more organic compound such as a high-molecular weight hydrocarbon, a carbohydrate, a natural or synthetic oil, an organic reducing agent, a carboxylic acid or polyacid, a carboxylic acid salt or derivative, an amine, an alcohol, a natural or synthetic resin, or mixtures of such compounds, to name a few.

In some embodiments the composite material 2 may also include an additional outer-protective layer (not shown) containing an inorganic protective material, which surrounds (coats) the metallic layer 4. Such inorganic protective materials may include metal oxides like alumina (Al₂O₃) and silica (SiO₂) that can protect the metallic layer 4 during storage and may also act as protective flux materials during laser processing. It is most useful if such inorganic outer protective layer is introduced as a smooth (e.g. glass-like) coating on the particles such that the surfaces are not hygroscopic.

Composite materials, such as the composite material 2 of FIG. 1, are expected to reduce physical and chemical defects in the corresponding melt processed materials—because the metallic layer 4 can contain chemically-resistant metals such as nickel which are inert to atmospheric reactants, and can also be surface processed to resist adsorption of atmospheric moisture.

Metal-coated composite materials such as the embodiment of FIG. 1 may be prepared using a variety of different methods depending upon the desired composition, size and geometry. Such methods include hydrometallurgical processing, physical and chemical vapor deposition, electroless plating, and gas-phase coating.

In some non-limiting processes a flux-containing particulate may be initially produced by agglomerating individual particles containing a flux composition using organic or inorganic binders, and then milling the resulting agglomerates to form a flux-binder mixture which is then cured to form flux-containing particles. The flux-containing particles may then be screened to a desired particle size, size range, or geometry required for a particular application. After the flux-containing particles are sized, a metal composition is deposited thereon to form coated composite materials such as the composite material 2 of FIG. 1.

For example, the flux-containing particles may be clad with nickel using hydrometallurgical processing—in which a dissolved nickel complex is precipitated onto the flux-containing particles by reduction with hydrogen optionally at elevated temperature and pressure. After the nickel is precipitated onto the flux-containing particles, the resulting metal-coated composite particles may be washed and dried. Additional metal coating and/or alloying may also occur in order to produce multi-layered or graded coatings, or to modify the composition of the metallic layer, using processes such as chemical vapor deposition (CVD).

Physical vapor deposition (PVD) may also be used to form metal-coated composite materials such as the composite particle 2 of FIG. 1. In such processes a metallic material is vaporized and transported in the form of a vapor through a vacuum or low pressure gaseous environment (or plasma) to previously-sized flux-containing particles where the metallic material condenses. PVD processes may be used to deposit films of metal elements or alloys. For example, PVD may be used to coat flux-containing particles that are suspended in a fluidized bed by a fluidization gas. The PVD may be non-directed or directed which can provide metal-coated composite materials having defined and repeatable coatings. Directed vapor deposition (DVD) may also be used in combination with electron beam-based (or ion beam-based aka sputter deposition) evaporation techniques to improve the yield and/or quality of metal-coated composite materials suitable for melt processing. PVD can be used to generate single-layer metallic coatings as well as multi-layer and compositionally-graded coatings.

Electroless plating may also be used to produce metal-coated composite materials such as the composite material 2 of FIG. 1. For example, an electroless plating solution containing a metal ion (such as nickel ion) and a soluble reducing agent (such as a hypophosphorate salt) may be mixed with flux-containing particles to form a metallic layer covering the flux-containing particles. Gas-phase coating may also be used by preparing a mixture of flux-containing particles in a flowable medium which is converted into an aerosol containing droplets of the flux-containing particles suspended in a carrier gas. The liquid contained in the aerosol may optionally be removed and the resulting gas-dispersed particles may optionally be dried by heating. The resulting gas-phase flux-containing particles may then be coated using, for example, physical vapor deposition (PVD) or chemical vapor deposition (CVD) with a reactive gas containing a metal such as nickel or a metal alloy.

Metal-coated composite materials, such as the composite particle 2 of FIG. 1, can be produced in various sizes ranging, for example, from about 1 to about 1000 micrometers in average diameter. In some embodiments the sizes range from about 5 to about 500 micrometers, or from about 20 to about 100 micrometers, in average diameter. Optimum ranges of size may vary according to application with, for example, ultrafine particulate required to fill narrow cracks, finer but not ultrafine particulate required for gas assisted feeding, and coarser particulate acceptable for preplaced or gravity fed powder processing. Such composite materials are formed such that a flux-to-metal volume ratio ranges from about 10:90 to about 90:10. In some embodiments the flux-to-metal volume ratio ranges from about 30:70 to about 70:30, or from about 40:60 to about 60:40. In other embodiments the flux-to-metal volume ratio ranges from about 45:55 to about 55:45, or is about 50:50.

FIG. 2 illustrates another embodiment of a composite material 8 in the form of fused particles comprising a metal alloy 10 and a flux composition 12, wherein the metal alloy 10 and the flux composition 12 are randomly distributed and randomly oriented within a fused composite lattice 13. In this non-limiting illustration the fused structure of the composite material 8 acts as a physical or chemical barrier that resists adsorption and permeation by atmospheric agents such as oxygen, nitrogen and moisture. For example, the fused structure may be in the form of conglomerate flux/metal glass particles which exhibit high resistance to moisture adsorption and low reactivity with atmospheric reactants—unlike merely agglomerated flux/metal materials which are often very prone to moisture adsorption and air reactivity due to their relatively high surface area and porosity.

The metal or alloy 10 in the fused composite material 8 of FIG. 2 may be a pure metal such as nickel or may be metal alloys such as superalloys based on nickel, iron and cobalt, optionally containing other metals, metalloids and nonmetals as described above. The metallic portion of the composite material 8 may be in the form of equivalent metallic particles having the same composition, which are evenly distributed throughout the fused particles, or may in the form of non-equivalent metallic particles having different compositions. In one example of the later embodiments, the fused composite material 8 may contain non-equivalent metallic particles having different compositions which, when melted and mixed together into a melt pool, can form a superalloy metal deposit.

As explained below in greater detail, the flux composition 12 comprises a flux material providing at least one protective function during melt processing of the composite material 8. Flux compositions may include one or more inorganic compound such as a metal oxide, a metal halide, a metal oxometallate, a metal carbonate, or mixtures thereof, and may also include one or more organic compound such as a high-molecular weight hydrocarbon, a carbohydrate, a natural or synthetic oil, an organic reducing agent, a carboxylic acid or polyacid, a carboxylic acid salt or derivative, an amine, an alcohol, a natural or synthetic resin, or mixtures of such compounds, to name a few.

Fused composite materials, such as the composite material 8 of FIG. 2, are expected to reduce physical and chemical defects in the corresponding melt-processed materials—because the fused structure is in the form of a glass-like composite lattice that is highly resistant to both moisture adsorption and reactivity with atmospheric agents such as oxygen and nitrogen.

Fused composite materials such as the embodiment of FIG. 2 may be prepared by dry mixing the metal alloy 10 and the flux composition 12 together and then fusing or melting the resulting conglomerate mixture into a liquid state using, for example, a high-temperature furnace. The resulting molten glass is then allowed to cool and solidify into a fused conglomerate glass form which may then be crushed or ground into different particle sizes and shapes.

Fused composite materials, such as the composite particle 8 of FIG. 2, can be produced in various sizes ranging, for example, from about 1 to about 1000 micrometers in average diameter. In some embodiments the sizes range from about 5 to about 500 micrometers, or from about 20 to about 100 micrometers, in average diameter. Such composite materials are formed such that a flux-to-metal volume ratio ranges from about 10:90 to about 90:10. In some embodiments the flux-to-metal volume ratio ranges from about 30:70 to about 70:30, or from about 40:60 to about 60:40. In other embodiments the flux-to-metal volume ratio ranges from about 45:55 to about 55:45, or is about 50:50.

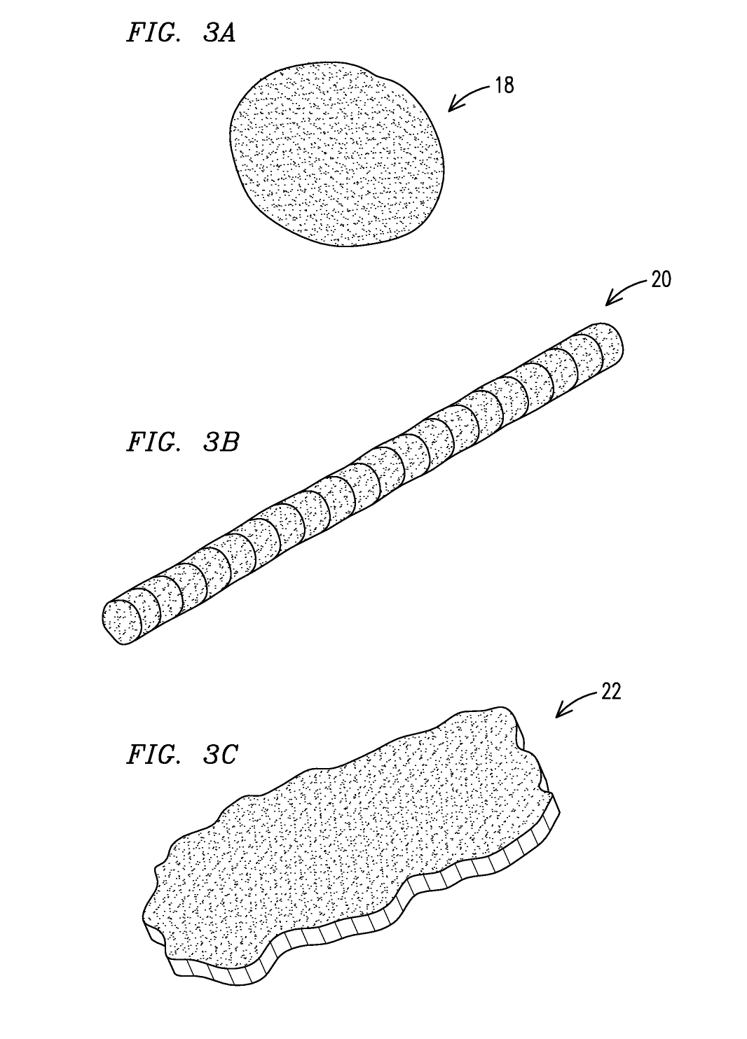

Both metal-coated and fused composite particles 2, 8 may be produced in a variety of different shapes and geometries. The non-limiting examples in FIGS. 3A-3C illustrate three different particle shapes that may be useful for laser powder depositions of the present disclosure. FIG. 3A shows a spherical composite particle 18—useful, e.g., for powder fed and fluidized bed processing. FIG. 3B shows a rod-like composite particle 20—useful, e.g., for weaving into threads and fabrics for making preforms that may be preplaced on a substrate or fed to the point of processing. FIG. 3C shows a flake-shaped composite particle 22—useful, e.g., when a bed of material is sought with high void volume ratio to allow introduction of a reactive gas to reach particulate surface.

The coated and fused composite materials described above, and illustrated in FIGS. 1 and 2, may be used in a large variety of processes involving melting and solidification to form metal deposits and components. Such applications include powder-fed (or directed) laser cladding, pre-placed powder laser cladding, selective laser melting (SLM), selective laser sintering (SLS), laser microcladding, fluidized bed laser processing, and powder cored wire-fed processing, to name just a few. In these and other applications, particles of the coated or fused composite material described above may be used as substitutes for conventional metal fillers and/or flux materials, or may be used along with conventional metal fillers and/or flux materials. Such processes may be applied to the fabrication and repair of metallic components (using, for example, additive manufacturing techniques) and also can be applied to bulk metal production, as explained below.

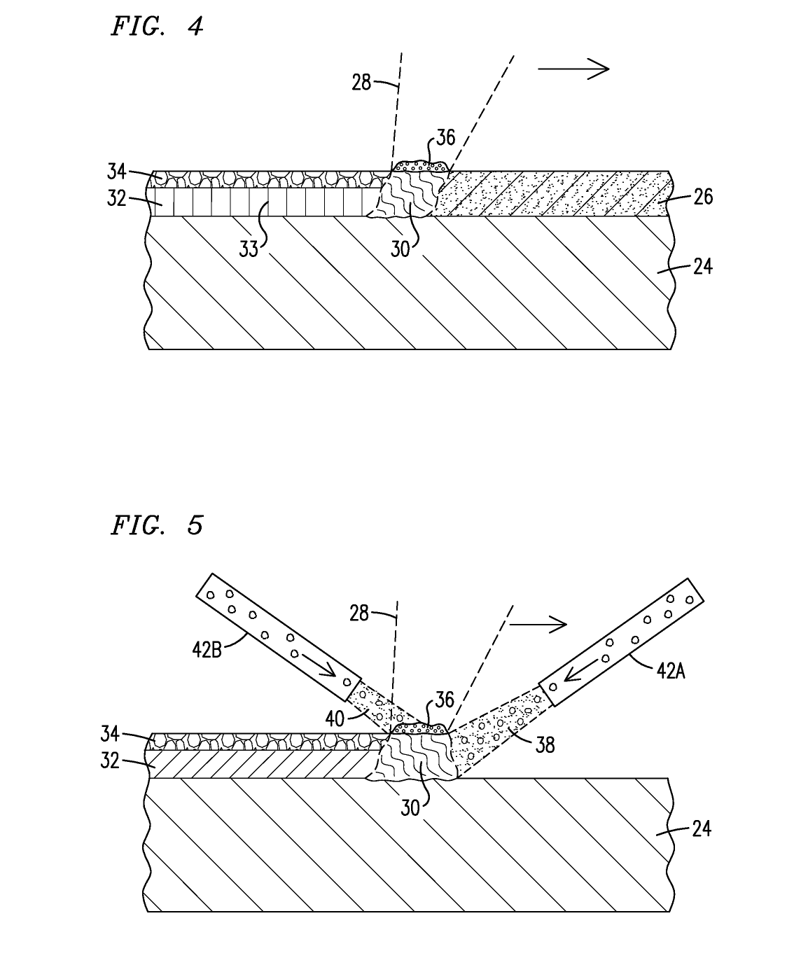

FIG. 4 illustrates one embodiment involving pre-placed powder laser cladding using either the metal-coated composite particles 2 or the fused composite particles 8 described and illustrated above. In this non-limiting example a composite material powder layer 26 is pre-placed onto a surface of a metal or non-metal substrate 24, and then an energy beam 28 (such as a laser beam) is traversed over the surface of the powder layer 26 which melts the powder layer 26 to form a melt pool 30, The melt pool is most generally comprised of a molten metal layer covered by a molten flux layer and sometimes blanketed by a protective gaseous envelope 36 produced by reactions of the energy beam with flux. The melt pool 30, which contains both the metal alloy and the flux composition of the composite particles, is then allowed to cool and solidify to form a metal deposit 32 that is generally covered by a slag layer 34.

The term “energy beam” is used herein in a general sense to describe a relatively narrow, propagating stream of particles or packets of energy. An energy beam 28 as used in this disclosure may include a light beam, a laser beam, a particle beam, a charged-particle beam, a molecular beam, etc., which upon contact with a material imparts kinetic (thermal) energy to the material.

In some embodiments the energy beam 28 is a diode laser beam having a generally rectangular cross-sectional shape, although other known types of energy beams may be used, such as electron beam, plasma beam, one or more circular laser beams, a scanned laser beam (scanned one, two or three dimensionally), an integrated laser beam, a pulsed (versus continuous wave) laser beam, etc. The rectangular shape may be particularly advantageous for embodiments having a relatively large area to be melted. In some embodiments the intensity and shape of the energy beam 28 are precisely controlled by employing laser scanning (rastering) optics to form a melt pool 30 having a precisely defined size, shape and depth.

The depth of the melt pool 30 may be controlled by altering the energy intensity, focal point and/or frequency of the energy beam 28. Suitable laser sources may include, for example, lower power lasers (e.g., 503 nm and 1.06 μm Nd:YAG lasers) and higher power lasers (e.g., 1.06 μm ytterbium fiber, 5.4 μm CO and 10.6 μm CO₂ lasers)—depending upon the amount of laser energy intensity required to obtain a desired melt pool depth. Other processing parameters such as the scanning (traversing) rate or the pulsing rate (i.e., for a pulsed laser beam) may also be adjusted to increase or decrease the depth of the resulting melt pool 30.

When the substrate 24 is a metallic substrate, then the metal deposit 32 may be in the form of a metallic cladding layer bonded to the surface of the metal substrate 24. As explained above, the energy beam parameters may be altered to control the depth of the melt pool 30. In embodiments involving cladding of an underlying metal substrate 24, the energy beam parameters may also be adjusted to melt an upper layer of the metal substrate to ensure that the resulting metal deposit 32 is tightly bound to the underlying metal substrate.

In other embodiments involving bulk production of metals, or involving the repair of hollow components, the substrate 24 may be in the form of fugitive support material. “Fugitive” means removable after formation of the cladding layer, for example, by direct (physical removal), by a mechanical process, by draining, by fluid flushing, by chemical leaching and/or by any other known process capable of removing the fugitive support material 24 from its position. Examples of fugitive support materials include powders (e.g., metal, glass, ceramic, fiber powders), solid objects (e.g., metal, glass, ceramic, composite, plastic, resinous structures, graphite, dry ice), woolen materials (e.g., steel wool, aluminum oxide wool, zirconia wool) and foamed materials (e.g., polymer foams, high-temperature spray foams) to name a few. Any material or structure capable of providing support and then being removable after the formation of the metal deposit 32 may serve as the fugitive support material 24. FIG. 5 illustrates another embodiment involving a powder-directed laser cladding (e.g., laser microcladding) using either the metal-coated composite particles 2 or the fused composite particles 8 described and illustrated above. In this non-limiting example a stream 38 of a composite material dispersed within a jet gas is directed into an energy beam 28 through at least one nozzle 42A—such that composite particles contained in the stream 38 are melted to form a melt pool 30 situated on a surface of a metal or non-metal substrate 24. In embodiments involving laser microcladding, for example, the laser beam 28 and the nozzle 42A are simultaneously traversed over the surface of the substrate 24 such that the resulting melt pool 30 cools and solidifies to produce a metal cladding layer 32 that is generally covered by a slag layer 34. At least one other stream 40 containing a different composite material, filler material, flux composition, or additive, may also be directed into the energy beam 28 via at least one additional nozzle 42B.

In some embodiments adherence of the composite particles to the surface of the substrate 24 may be increased by initially contacting the composite particles with an adherent substance such as water, an alcohol, a lacquer or a binder. Such pre-wetting of the composite powder with a glue-like substance can also improve inter-layer adherence when multiple adjacent metal layer deposits are formed.

As explained and illustrated above, the composite materials 2, 8 contain both a metal portion 4, 10, and a flux composition 6, 12 which provides at least one protective function during melt processing. The flux composition 6, 12 and the resulting slag layer 34 may provide a number of beneficial functions that can improve the chemical and/or mechanical properties of deposited metals formed by melt processing of the composite materials described herein.

First, the flux composition and the resulting slag layer 34 can both function to shield both the region of the melt pool 30 and the solidified (but still hot) melt-processed layer 32 from the atmosphere. The slag floats to the surface to separate the molten or hot metal from the atmosphere, and the flux composition may be formulated to produce at least one shielding agent which generates at least one shielding gas upon exposure to laser photons or heating. In some embodiments shielding gases may coalesce into a gaseous envelope 36 covering the melt pool 30, as illustrated in FIGS. 4 and 5. Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂). The presence of the slag layer 34 and the optional shielding gas 36 can avoid or minimize the need to conduct melt processing in the presence of inert gases (such as helium and argon) or within a sealed chamber (e.g., vacuum chamber or inert gas chamber) or using other specialized devices for excluding air.

Second, the slag layer 34 can act as an insulation layer that allows the resulting melt-processed layer 32 to cool slowly and evenly, thereby reducing residual stresses that can contribute to post weld cracking, reheat or strain age cracking, and secondary reaction zone formation. Such slag blanketing over and adjacent to the deposited metal layer 32 can further enhance heat conduction towards the substrate 24, which in some embodiments can promote directional solidification to form elongated (uniaxial) grains 33 in the melt-processed layer 32 (see FIG. 4).

Third, the slag layer 34 can help to shape and support the melt pool 30 to keep them close to a desired height/width ratio (e.g., a 1/3 height/width ratio). This shape control and support further reduces solidification stresses that could otherwise be imparted to the melt-processed layer 32. Along with shape and support, the slag layer 34 can also be produced from a flux composition that is formulated to enhance surface smoothness of the melt-processed layer 34. Enhanced surface smoothness can be beneficial in some embodiments wherein the melt-processed layer 32 is a superalloy layer that is subsequently coated with a diffusion coating such as a platinum aluminide coating. In these embodiments the enhanced surface smoothness can reduce the formation of detrimental secondary reaction zones (SRZs) which can jeopardize the physical and chemical properties of diffusion-coated superalloy components.

Fourth, the flux composition and the slag layer 34 can provide a cleansing effect for removing trace impurities that contribute to inferior properties. Such cleaning may include deoxidation of the melt pool 30. Some flux compositions may also be formulated to contain at least one scavenging agent capable of removing unwanted impurities from the melt pool. Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂), and other agents known to react with detrimental elements such as sulfur and phosphorous and elements known to produce low melting point eutectics to form low-density byproducts expected to “float” into a resulting slag layer 34.

Fifth, the flux composition and the slag layer 34 can increase the proportion of thermal energy delivered to the surface of the substrate 24. This increase in heat absorption may occur due to the composition and/or form of the flux composition. In terms of composition the flux may be formulated to contain at least one compound capable of absorbing laser energy at the wavelength of a laser energy beam used as the energy beam 28. Increasing the proportion of a laser absorptive compound causes a corresponding increase in the amount of laser energy (as heat) applied to the substrate surface. This increase in heat absorption can provide greater versatility by allowing the use of smaller and/or lower power laser sources that may be capable of producing a relatively shallower melt pool 30—which may be useful, for example, in laser microcladding. In some cases the laser absorptive compound could also be an exothermic compound that decomposes upon laser irradiation to release additional heat. An example of such composite exothermic particulate would be particles with a CO₂ generating core (e.g. including a carbonate) surrounded by aluminum and finally coated with nickel. Nickel coated aluminum powder is in fact proposed as a fuel for propulsion on Mars where CO₂ is plentiful and which provides for such exothermic reaction.

The form of the composite material 2, 8 and the resulting layer 26 can also affect laser absorption by altering layer thickness and/or particle size. In such cases absorption of laser heating generally increases as the thickness of the layer 26 (see FIG. 4) increases. Increasing the thickness of the composite material layer 26 also increases the thickness of a resulting molten slag blanket, which can further enhance absorption of laser energy. The thickness of the powder layer 26 (see FIG. 4) in methods of the present disclosure typically ranges from about 1 mm to about 15 mm. In some cases the thickness ranges from about 3 mm to about 12 mm, while in other instances the thickness ranges from about 5 mm to about 10 mm.

Reducing the average particle size of the composite materials 2, 8 also causes an increase in laser energy absorption (presumably through increased photon scattering within the bed of fine particles and increased photon absorption via interaction with increased total particulate surface area). In terms of the particle size, whereas commercial fluxes generally range in average particle size from about 0.5 mm to about 2 mm (500 to 2000 microns) in diameter (or approximate dimension if not rounded), composite materials in some embodiments of the present disclosure range in average particle size from about 1 to 1000 microns in diameter, or from about 5 to 500 microns, or from about 20 to 100 microns.

Additionally, the flux composition may be formulated to compensate for loss of volatilized or reacted elements during processing or to actively contribute elements to the melt-processed layer 32 that are not otherwise contained in metal alloy 4, 10. Such vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements. Certain oxometallates as described below can also be useful as vectoring agents.

Flux compositions contained in composite materials of the present disclosure may include one or more inorganic compound selected from metal oxides, metal halides, metal oxometallates and metal carbonates. Such compounds may function as (i) optically transmissive vehicles; (ii) viscosity/fluidity enhancers; (iii) shielding agents; (iv) scavenging agents; and/or (v) vectoring agents.

Suitable metal oxides include compounds such as Li₂O, SeO, B₂O₃, B₆O, MgO, Al₂O₃, SiO₂, CaO, Sc₂O₃, TiO, TiO₂, Ti₂O₃, VO, V₂O₃, V₂O₄, V₂O₅, Cr₂O₃, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, Y₂O₃, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, HfO₂, Ta₂O₅, WO₂, WO₃, ReO₃, Re₂O₇, PtO₂, Au₂O₃, La₂O₃, CeO₂, Ce₂O₃, and mixtures thereof, to name a few.

Suitable metal halides include compounds such as LiF, LiCl, LiBr, LiI, Li₂NiBr₄, Li₂CuCl₄, LiAsF₆, LiPF₆, LiAlCl₄, LiGaCl₄, Li₂PdCl₄, NaF, NaCl, NaBr, Na₃AlF₆, NaSbF₆, NaAsF₆, NaAuBr₄, NaAlCl₄, Na₂PdCl₄, Na₂PtCl₄, MgF₂, MgCl₂, MgBr₂, AlF₃, KCl, KF, KBr, K₂RuCl₅, K₂IrCl₆, K₂PtCl₆, K₂PtCl₆, K₂ReCl₆, K₃RhCl₆, KSbF₆, KAsF₆, K₂NiF₆, K₂TiF₆, K₂ZrF₆, K₂PtI₆, KAuBr₄, K₂PdBr₄, K₂PdCl₄, CaF₂, CaF, CaBr₂, CaCl₂, CaI₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, Ga₂Cl₄, GaCl₃, GaF₃, GaI₃, GaBr₂, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, YBr, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgSbF₆, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, CsF, CsI, BaCl₂, BaF₂, BaI₂, BaCoF₄, BaNiF₄, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaF₃, LaI₃, CeBr₃, CeCl₃, CeF₃, CeF₄, CeI₃, and mixtures thereof, to name a few.

Suitable oxometallates include compounds such as LiIO₃, LiBO₂, Li₂SiO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof, to name a few.

Suitable metal carbonates include compounds such as Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃)(OH)₂, and mixtures thereof, to name a few.

Optically transmissive vehicles include metal oxides, metal salts and metal silicates such as alumina (Al₂O₃), silica (SiO₂), zirconium oxide (ZrO₂), sodium silicate (Na₂SiO₃), potassium silicate (K₂SiO₃), and other compounds capable of optically transmitting laser energy (e.g., as generated from NdYAG, CO₂ and Yt fiber lasers).

Viscosity/fluidity enhancers include metal fluorides such as calcium fluoride (CaF₂), cryolite (Na₃AlF₆) and other agents known to enhance viscosity and/or fluidity (e.g., reduced viscosity with CaO, MgO, Na₂O, K₂O and increasing viscosity with Al₂O₃ and TiO₂) in welding applications.

Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂).

Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂) and other agents known to react with detrimental elements such as sulfur and phosphorous to form low-density byproducts expected to “float” into a resulting slag layer 34.

Vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements.

In some embodiments the flux composition may also contain certain organic fluxing agents. Examples of organic compounds exhibiting flux characteristics include high-molecular weight hydrocarbons (e.g., beeswax, paraffin), carbohydrates (e.g., cellulose), natural and synthetic oils (e.g., palm oil), organic reducing agents (e.g., charcoal, coke), carboxylic acids and dicarboxylic acids (e.g., abietic acid, isopimaric acid, neoabietic acid, dehydroabietic acid, rosins), carboxylic acid salts (e.g., rosin salts), carboxylic acid derivatives (e.g., dehydro-abietylamine), amines (e.g., triethanolamine), alcohols (e.g., high polyglycols, glycerols), natural and synthetic resins (e.g., polyol esters of fatty acids), mixtures of such compounds, and other organic compounds.

In some embodiments flux compositions include:
5-60% by weight of metal oxide(s);
10-70% by weight of metal fluoride(s);
5-40% by weight of metal silicate(s); and
0-40% by weight of metal carbonate(s),
   based on a total weight of the flux composition.

In some embodiments flux compositions include:
5-40% by weight of Al₂O₃, SiO₂, and/or ZrO₂;
10-50% by weight of metal fluoride(s);
5-40% by weight of metal silicate(s);
0-40% by weight of metal carbonate(s); and
15-30% by weight of other metal oxide(s),
   based on a total weight of the flux composition.

In some embodiments flux compositions include:
5-60% by weight of at least one of Al₂O₃, SiO₂, Na₂SiO₃ and K₂SiO₃;
10-50% by weight of at least one of CaF₂, Na₃AlF₆, Na₂O and K₂O;
1-30% by weight of at least one of CaCO₃, Al₂(CO₃)₃, NaAl(CO₃)(OH)₂, CaMg(CO₃)₂, MgCO₃, MnCO₃, CoCO₃, NiCO₃ and La₂(CO3)₃;
15-30% by weight of at least one of CaO, MgO, MnO, ZrO₂ and TiO₂; and
0-5% by weight of at least one of a Ti metal, an Al metal and CaTiSiO₅,
   based on a total weight of the flux composition.

In some embodiments the flux compositions include:
5-40% by weight of Al₂O₃;
10-50% by weight of CaF₂;
5-30% by weight of SiO₂;
1-30% by weight of at least one of CaCO₃, MgCO₃ and MnCO₃;
15-30% by weight of at least two of CaO, MgO, MnO, ZrO₂ and TiO₂; and
0-5% by weight of at least one of Ti, Al, CaTiSiO₅, Al₂(CO₃)₃ and NaAl(CO₃)(OH)₂,
   based on a total weight of the flux composition.

In some embodiments the flux composition contains at least two compounds selected from a metal oxide, a metal halide, an oxometallate and a metal carbonate. In other embodiments the flux composition contains at least three of a metal oxide, a metal halide, an oxometallate and a metal carbonate. In still other embodiments the flux composition may contain a metal oxide, a metal halide, an oxometallate and a metal carbonate.

Viscosity of the molten slag may be increased by including at least one high melting-point metal oxide which can act as thickening agent. Thus, in some embodiments the flux composition is formulated to include at least one high melting-point metal oxide. Examples of high melting-point metal oxides include metal oxides having a melting point exceeding 2000° C.—such as Sc₂O₃, Cr₂O₃, Y₂O₃, ZrO₂, HfO₂, La₂O₃, Ce₂O₃, Al₂O₃ and CeO₂.

In some embodiments the flux compositions of the present disclosure include zirconia (ZrO₂) and at least one metal silicate, metal fluoride, metal carbonate, metal oxide (other than zirconia), or mixtures thereof. In such cases the content of zirconia is often greater than about 7.5 percent by weight, and often less than about 25 percent by weight. In other cases the content of zirconia is greater than about 10 percent by weight and less than 20 percent by weight. In still other cases the content of zirconia is greater than about 3.5 percent by weight, and less than about 15 percent by weight. In still other cases the content of zirconia is between about 8 percent by weight and about 12 percent by weight.

In some embodiments the flux compositions of the present disclosure include a metal carbide and at least one metal oxide, metal silicate, metal fluoride, metal carbonate, or mixtures thereof. In such cases the content of the metal carbide is less than about 10 percent by weight. In other cases the content of the metal carbide is equal to or greater than about 0.001 percent by weight and less than about 5 percent by weight. In still other cases the content of the metal carbide is greater than about 0.01 percent by weight and less than about 2 percent by weight. In still other cases the content of the metal carbide is between about 0.1 percent and about 3 percent by weight.

In some embodiments the flux compositions of the present disclosure include at least two metal carbonates and at least one metal oxide, metal silicate, metal fluoride, or mixtures thereof. For example, in some instances the flux compositions include calcium carbonate (for phosphorous control) and at least one of magnesium carbonate and manganese carbonate (for sulfur control). In other cases the flux compositions include calcium carbonate, magnesium carbonate and manganese carbonate. Some flux compositions comprise a ternary mixture of calcium carbonate, magnesium carbonate and manganese carbonate such that a proportion of the ternary mixture is equal to or less than 30% by weight relative to a total weight of the flux material. A combination of such carbonates (binary or ternary) is beneficial in most effectively scavenging multiple tramp elements.

All of the percentages (%) by weight enumerated above are based upon a total weight of the flux material being 100%.

Commercially availed fluxes may be also used to form composite materials of the present disclosure. Examples includes flux materials sold under the names Lincolnweld P2007, Bohler Soudokay NiCrW-412, ESAB OK 10.16 and 10.90, Special Metals NT100, Oerlikon OP76, Bavaria WP 380, Sandvik 50SW, 59S or SAS1, and Avesta 805. Such commercial fluxes may be ground to a smaller particle size range before use.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A composite material comprising a metal alloy and a flux composition, wherein a volume ratio of the flux composition to the metal alloy ranges from about 30:70 to about 70:30.

2. The composite material of claim 1, wherein the metal alloy is a superalloy.

3. The composite material of claim 1, wherein the flux composition comprises a metal oxide and at least one selected from the group consisting of a metal halide, a metal oxometallate and a metal carbonate.

4. The composite material of claim 1, wherein the flux composition comprises:
a metal oxide selected from the group consisting of Li₂O, SeO, B₂O₃, B₆O, MgO, Al₂O₃, SiO₂, CaO, Sc₂O₃, TiO, TiO₂, Ti₂O₃, VO, V₂O₃, V₂O₄, V₂O₅, Cr₂O₃, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, Y₂O₃, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, HfO₂, Ta₂O₅, WO₂, WO₃, ReO₃, Re₂O₇, PtO₂, Au₂O₃, La₂O₃, CeO₂, Ce₂O₃, and mixtures thereof; and
at least one of:
(i) a metal halide selected from the group consisting of LiF, LiCl, LiBr, LiI, Li₂NiBr₄, Li₂CuCl₄, LiAsF₆, LiPF₆, LiAlCl₄, LiGaCl₄, Li₂PdCl₄, NaF, NaCl, NaBr, Na₃AlF₆, NaSbF₆, NaAsF₆, NaAuBr₄, NaAlCl₄, Na₂PdCl₄, Na₂PtCl₄, MgF₂, MgCl₂, MgBr₂, AlF₃, KCl, KF, KBr, K₂RuCl₅, K₂IrCl₆, K₂PtCl₆, K₂PtCl₆, K₂ReCl₆, K₃RhCl₆, KSbF₆, KAsF₆, K₂NiF₆, K₂TiF₆, K₂ZrF₆, K₂PtI₆, KAuBr₄, K₂PdBr₄, K₂PdCl₄, CaF₂, CaF, CaBr₂, CaCl₂, CaI₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, Ga₂Cl₄, GaCl₃, GaF₃, GaI₃, GaBr₂, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, YBr, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgSbF₆, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, CsF, CsI, BaCl₂, BaF₂, BaI₂, BaCoF₄, BaNiF₄, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaF₃, LaI₃, CeBr₃, CeCl₃, CeF₃, CeF₄, CeI₃, and mixtures thereof;
(ii) an oxometallate selected from the group consisting of LiIO₃, LiBO₂, Li₂SiO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof; and
(iii) a metal carbonate selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃)(OH)₂, and mixtures thereof.

5. The composite material of claim 1, in the form of particles comprising a core surrounded by a metallic layer, wherein:
the core comprises the flux composition; and
the metallic layer comprises the metal alloy.

6. The composite materials of claim 5, wherein the metallic layer satisfies at least one condition selected from the group consisting of
(i) the metallic layer is a compositionally-graded layer,
(ii) the metallic layer is in the form of a plurality of equivalent metallic layers comprising the metal alloy,
(iii) the metallic layer is in the form of a plurality of different metallic layers containing different metallic compositions, and
(iv) the metallic layer is coated by at least one protective layer comprising an inorganic protective material.

7. The composite material of claim 1, in the form of a fused material comprising the metal alloy and the flux composition, wherein the metal alloy and the flux composition are randomly distributed and randomly oriented within the fused material.

8. A composite material comprising a superalloy and a flux composition.

9. The composite material of claim 8, wherein a volume ratio of the flux composition to the superalloy ranges from about 30:70 to about 70:30.

10. The composite material of claim 8, in the form of particles comprising a core surrounded by a metallic layer, wherein:
the core comprises the flux composition; and
the metallic layer comprises the superalloy.

11. The composite materials of claim 10, wherein the metallic layer satisfies at least one condition selected from the group consisting of
(i) the metallic layer is a compositionally-graded layer,
(ii) the metallic layer is in the form of a plurality of equivalent metallic layers comprising the metal alloy,
(iii) the metallic layer is in the form of a plurality of different metallic layers containing different metallic compositions, and
(iii) the metallic layer is coated by at least one protective layer comprising an inorganic protective material.

12. The composite material of claim 8, in the form of a fused material comprising the superalloy and the flux composition, wherein the superalloy and the flux composition are randomly distributed and randomly oriented within the fused material.

13. A composite material, comprising a metal alloy and a flux composition comprising a metal oxide and at least one selected from the group consisting of a metal halide, a metal oxometallate and a metal carbonate.

14. The composite material of claim 13, wherein a volume ratio of the flux composition to the metal alloy ranges from about 30:70 to about 70:30.

15. The composite material of claim 13, in the form of particles comprising a core surrounded by a metallic layer, wherein:
the core comprises the flux composition; and
the metallic layer comprises the metal alloy.

16. The composite material of claim 15, wherein the metallic layer satisfies at least one condition selected from the group consisting of
(i) the metallic layer is a compositionally-graded layer,
(ii) the metallic layer is in the form of a plurality of equivalent metallic layers comprising the metal alloy,
(iii) the metallic layer is in the form of a plurality of different metallic layers containing different metallic compositions, and
(iv) the metallic layer is coated by at least one protective layer comprising an inorganic protective material.

17. The composite material of claim 13, in the form of a fused material comprising the metal alloy and the flux composition, wherein the metal alloy and the flux composition are randomly distributed and randomly oriented within the fused material.

18. A process comprising melting the composite material of claim 1 and allowing a resulting molten material to cool to form a metal deposit.

19. A process comprising melting the composite material of claim 8 and allowing a resulting molten material to cool to form a metal deposit.

20. A process comprising melting the composite material of claim 13 and allowing a resulting molten material to cool to form a metal deposit.
